(19) United States
(12) Patent Application Publication
(10) Pub. No.: US 2004/0213128 A1
(43) Pub. Date: Oct. 28, 2004

(54) Beam deflector for a data storage device

(76) Inventor: Daniel R. Marshall, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/423,694

(22) Filed: Apr. 25, 2003

(51) Int. Cl. G11B 9/10

(52) U.S. Cl. 369/101; 369/126

(57) ABSTRACT

A data storage device is provided, such data storage device including a storage medium having a data storage location, and at least one emitter adapted to emit an electron beam generally aligned with the data storage location. The data storage device also includes a beam deflector including plural steering electrodes configured to selectively adjust positional alignment of the electron beam relative the data storage location.

### BACKGROUND

Various types of data storage devices are known, including optical storage devices, magnetic storage devices, electron data storage devices, etc. Electron data storage devices, in particular, include electron emitters, or emitting sources, and electron optics adapted to generate and focus electron beams. The electron beams are used to produce a spot on the surface of a storage medium. The spot produced by the electron beams may be used to both read from and write data to the storage medium in the storage device.

The extremely short wavelength associated with electron beams results in the ability to define relatively small recorded spots in comparison to the spots recorded using, for example, an optical or magnetic storage device. The smaller recorded spots facilitate a higher density of recorded information in the same way that an electron microscope offers better spatial resolution than one that uses visible light.

High storage density necessitates fine control of alignment and focus of an electron beam relative to storage locations on the storage medium. Small amounts of defocus may adversely affect the formation and reading of recorded spots on the storage medium. For example, a high level of defocus increases error rate of the reading and/or writing process. Additionally, defocus may increase the size of the recorded spots and necessitate the use of more powerful electron emitting sources during the reading and/or writing process.

### SUMMARY

A data storage device is provided, such data storage device including a storage medium having a data storage location, and at least one emitter adapted to emit an electron beam generally aligned with the data storage location. The data storage device also includes a beam deflector including plural steering electrodes configured to selectively adjust positional alignment of the electron beam relative the data storage location.

### BRIEF DESCRIPTION OF THE DRAWINGS

FIG. 1 is a schematic cross-sectional side view of an exemplary electron data storage device according to an embodiment of the present invention.

FIG. 2 is a schematic diagram illustrating operation of the exemplary electron data storage device shown in FIG. 1.

FIG. 3 is a schematic side view of a flat emitter suitable for use within the electron data storage device shown in FIG. 1.

FIG. 4 is an isometric view of an exemplary electron emitter with a beam deflector in the form of a partitioned lens according to an embodiment of the invention.

FIG. 5 is a schematic illustration of the electron emitter of FIG. 4, illustrating adjustment of the position of the electron beam.

FIG. 6 is a schematic illustration of an embodiment of a control circuit for the beam deflector of FIG. 4.

FIG. 7 is a flow diagram depicting a method of aligning an electron beam to a data storage location on a storage medium in accordance with an embodiment of the invention.

### DETAILED DESCRIPTION

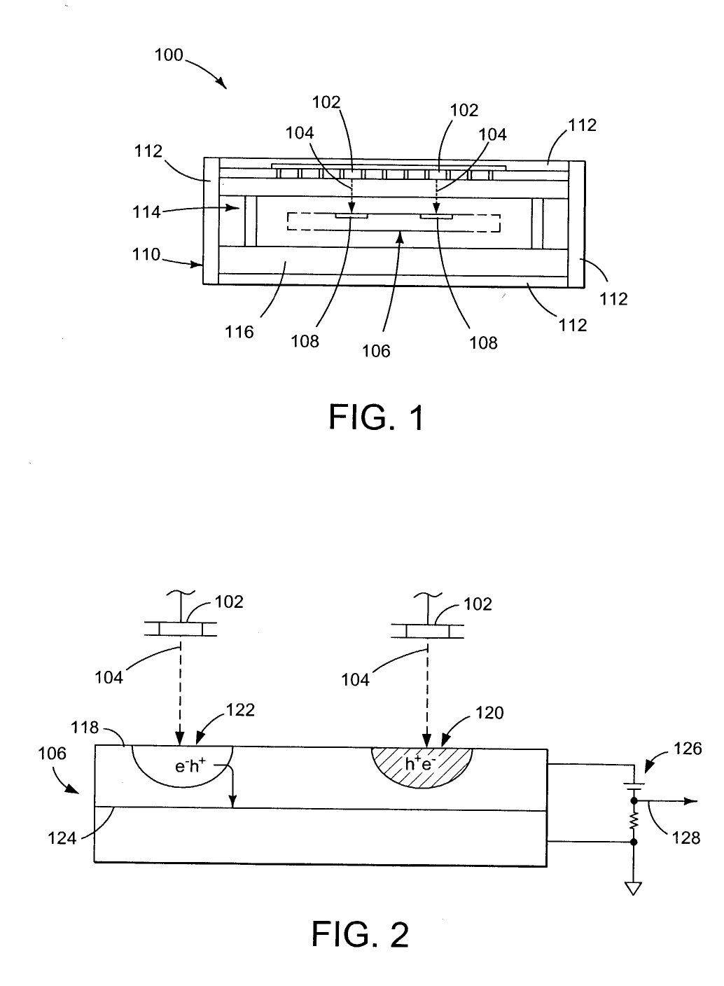

Referring initially to FIG. 1, an electron data storage device according to an embodiment of the present invention is shown generally at 100. Storage device 100 includes a plurality of electron emitters 102 configured to generate electron beams 104. The electron beams may be configured to bombard storage medium 106. As described below, the electron beams may be focused and generally aligned with a storage location or area 108 on storage medium 106.

One such storage device is described and disclosed, for example, in U.S. Pat. No. 5,557,596 to Gibson et al., the disclosure of which is hereby incorporated by reference. It is within the context of the exemplary storage device of FIG. 1 that the present beam deflector is described. Other types and/or configurations of electron data storage devices where electron beams are used to read or write data on a storage medium are, of course, also possible.

Briefly, in the depicted embodiment, a casing 110 typically is adapted to maintain storage medium 106 in partial vacuum. Specifically, casing 110 may include a plurality of walls 112 that define an interior space 114. Walls 112 may be coupled together such that at least a partial vacuum may be maintained within interior space 114. It should be appreciated that different configurations for casing 110 are contemplated.

As described above, each electron emitter 102 within interior space 114 may correspond to one or more storage areas 108 provided on storage medium 106. Where each electron emitter corresponds to a number of storage areas, storage device 100 typically is adapted to scan, or otherwise effect, relative movement between emitters 102 and storage medium 106. Exemplary storage device 100 may include a micromover 116, which may scan or move the storage medium 106 with respect to the electron emitters. For example, micromover 116 may be adapted to move storage medium 106 to different positions, so that electron emitters 102 may be aligned with different storage areas. Alternatively, a micromover may be adapted to move the electron emitters relative to the storage area such that the electron beams scan across the storage medium. Any suitable micromover may be used to obtain relative motion between electron emitters 102 and storage medium 106.

Electron emitters 102 are configured to generate and emit electron beam currents, also referred to herein, as electron beams, such that the electron beams selectively bombard storage areas 108 on storage medium 106. The electron emitters suitable for use with storage device 100 produce electron beams narrow enough to achieve the desired data bit or spot density on storage medium 106.

The electron beams produced via the electron emitters may be used to read or write. Writing may be accomplished by temporarily increasing the power density of the electron beam currents to modify the surface state of the storage area. For example, a data storage area in a first state may represent a “1” bit, while a data storage area in a second state may represent a “0” bit. Moreover, the storage areas may be modified to different degrees to represent more than two bits. Reading may be accomplished by detecting the effect of the storage area on the electron beams, or the effect of the electron beams on the storage area. It should be appreciated that the modifications to the storage area may be permanent or reversible (temporary). A permanently modified storage medium may be suitable for write-once-read-many memory (WORM).

In some embodiments, storage medium 106 may be constructed of a material having a structural state that may be changed from crystalline to amorphous by electron beams. To change from the amorphous to the crystalline state, the beam power density may be increased and then slowly decreased. This increase/decrease may heat the amorphous area and then slowly cool allowing the area time to anneal into its crystalline state. To change from the crystalline to amorphous state, the beam power density may be increased to a high level and then rapidly reduced.

As an example, FIG. 2 illustrates an embodiment that may be used to read and write data on to the storage medium. Specifically, FIG. 2 illustrates a storage device 106 incorporating a diode structure 118 that may be used to determine the state of storage areas 120, 122. Diode structure 118 may be a pn junction, a Schottky barrier or any other type of suitable electronic valve. Also, although not specifically described here, it will be appreciated that other methods may be used to read and write data from the storage medium, including, but not limited to, collecting and measuring backscaftered or secondary electrons.

In the depicted embodiment, the storage medium is arranged as a diode having two layers. By way of example, one of the layers is p-type and the other is n-type. The storage medium may be connected to an external circuit that reverse-biases the storage medium. With this arrangement, data bits may be stored by locally altering the surface of a diode in such a way that the collection efficiency for minority carriers generated near an altered region or written area 120 is different from that of an unaltered region or unwritten area 122. It should be noted that charge carriers (holes and electrons) are present in the storage medium. The more abundant charge carriers are called majority carriers; the less abundant are called minority carriers. In n-type semiconductor material, electrons are the majority carriers and holes are the minority carriers. In p-type semiconductor material, the electrons are the minority carriers and the holes are the majority carriers.

The collection efficiency for minority carriers may be defined as the fraction of minority carriers generated by the electrons that are swept across the diode junction 124 when it is biased by an exemplary external circuit 126. The minority carriers thus cause a signal current 128 to flow in the external circuit. The magnitude of the current resulting from the minority carriers typically depends on the state of the storage area.

In operation, electron emitters 102 emit narrow beams of electrons 104 onto the surface of storage medium 106. The incident electrons excite electron-hole pairs (represented by e−h+ in FIG. 2) near the surface of the diode. As used herein, a hole is an electric charge carrier with a positive charge, equal in magnitude, but opposite in polarity, to the charge on an electron. Because the medium is reverse-biased by the external circuit, the minority carriers generated by the incident electrons may be swept toward diode junction 124. Electrons that reach diode junction 124 generally are swept across the junction. In other words, minority carriers that do not recombine with majority carriers before reaching the junction generally are swept across the junction, causing a current to flow in external biasing circuit 126.

Writing onto storage medium 106 may be accomplished by increasing the power density of electron beams 104 enough to locally alter some property or properties of the diode in the vicinity of the incident beam. The alteration affects the number of minority carriers swept across diode junction 124 when the same area is irradiated with lower power density “read” electron beams. For example, the recombination rate in written area 120 may be increased relative to unwritten area 122 so that the minority carriers generated in the written area have an increased probability of recombining with majority carriers before they have a chance to reach and cross junction 124. Hence, a smaller current flows in the external circuit 126 when the read electron beams are incident upon a written area than when the beams are incident upon an unwritten area. Conversely, it is also possible to start with a different diode structure with a high recombination rate, and to write bits by locally reducing the recombination rate. The resulting current constitutes output signal 128 which may indicate a stored bit.

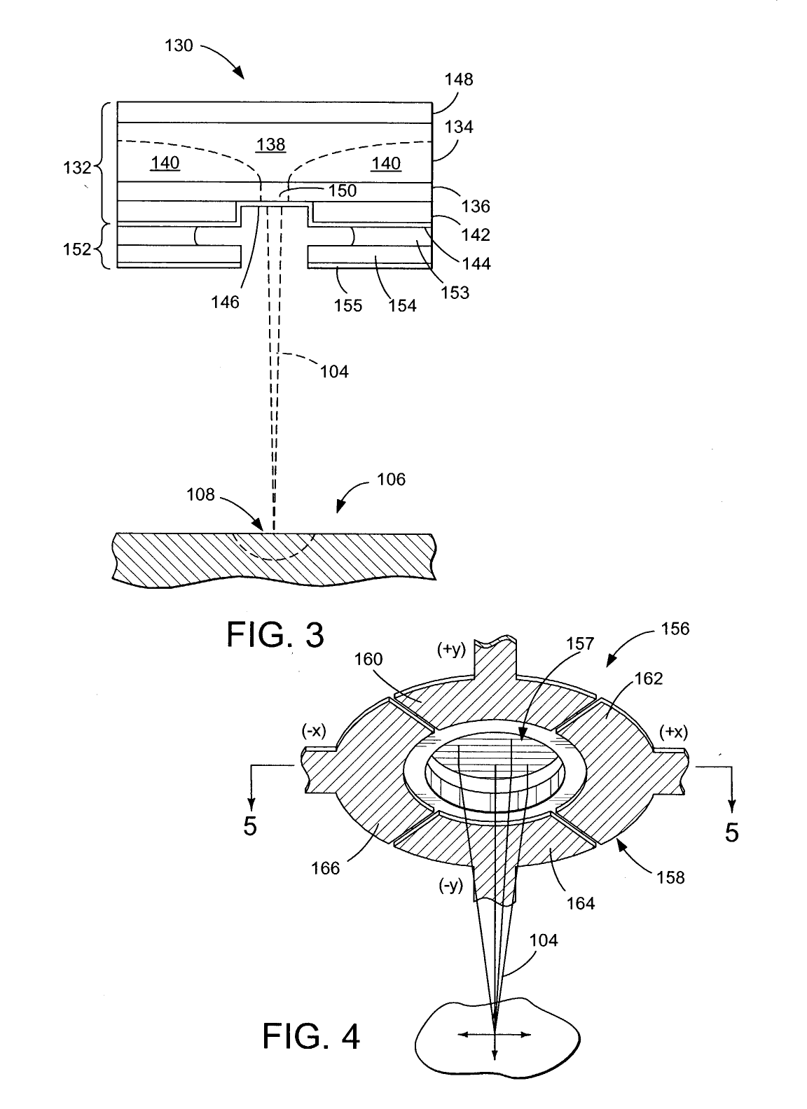

Electron emitters 102 may be any suitable electron source, including, but not limited to flat emitters. FIG. 3 illustrates an exemplary flat emitter 130 having an electron emission structure, indicated generally at 132. Although the present flat emitter configuration is described in detail below, it should be appreciated that other configurations for flat emitter 130 and electron emission structure 132 are possible.

Flat emitter 130 may include an n++semiconductor substrate 134 (such as silicon) and a semiconductor layer 136. Substrate 134 may be fabricated such that it includes a volcano-like, funnel-like, or nozzle-like active region 138. Active region 138 may be surrounded by an isolation region 140 that limits the area from which the active region can emit electrons. In addition to limiting the geometry of the active region, in some embodiments, the isolation region may isolate the active region from neighboring active regions. In other embodiments, it will be understood the active regions of contiguous electron emitters may be connected together.

Flat emitter 130 includes an emission electrode 142 formed on semiconductor layer 136 of substrate 134. Emission electrode 142 may be used to supply voltage to semiconductor layer 136. In addition to the emission electrode, flat emitter 130 includes a conductive layer 144 that covers emission electrode 142 and a portion of the outer surface of semiconductor layer 136. Conductive layer 144 thus may define an emission surface 146. The conductive layer provides electrical contact across the emission surface and enable an electric field to be applied across the emission surface.

In some embodiments, flat emitter 130 also includes a back contact 148 formed on the substrate on a side opposite that on which the semiconductor layer is formed. When provided, the back contact establishes an equipotential surface for internal fields in the semiconductor substrate.

During operation, different potentials may be applied (e.g., with on- or off-chip drivers) across substrate 134 via emission electrode 142 and back contact 148. The resulting emission electrode voltage causes electrons to be injected from active region 138 of substrate 134 into region 150 of semiconductor layer 136. The electrons thus may be emitted from emission surface 146 of conductive layer 144. This emission results in an electron beam 104 that impinges the target on storage medium 106.

Electron optics or other focusing structures 152 may be incorporated within the electron emitters. Focusing structure 152 includes an insulating layer 153, a lens electrode (also referred to herein as a focusing electrode) 154, and a conductive layer 155. Insulating layer 153 isolates the emission electrode 142 from focusing electrode 154. Like conductive layer 144, conductive layer 155 provides a contact over the corresponding electrode such that an electric field can be applied thereto.

The focusing structure is used to focus the electron beams onto storage medium 106. For example, the focusing electrode or plurality of focusing electrodes (and the conductive layer) may be formed so as to define an aperture (e.g., a ring, etc.) through which electron beams may pass. In use, a potential or voltage is applied to one or more of these focusing electrodes. The electric field resulting from application of a voltage to one or more focusing electrodes affects the focus of the electron beam upon the storage medium. Accordingly, the focus may be adjusted by varying the potential applied to these electrodes. A voltage may also be applied to storage medium 106 to accelerate and/or decelerate the field-emitted electrons.

As described above, the electron emitters may be other types of suitable electron sources. For example, the electron emitters may be point emitters. Point emitters, also referred to as tip emitters, typically are cone-shaped and have emitter tips or points from which narrow, focused beams of electrons may be emitted.

During operation, a pre-selected potential difference may be applied between the point emitter and a corresponding extractor electrode or gate. The extractor electrode may be a circular gate that surrounds the point emitter. Due at least in part to the sharp point of the emitter, an electron beam current may be extracted from the emitter and directed with a high degree of precision towards the data storage location. A beam deflector, as described in more detail below, deflects the electron beam after emission from the point emitter. By managing the amount and type of deflection, the position of the electron beam may be controlled.

FIG. 4 illustrates a flat emitter 156 according to an embodiment of the present invention. Flat emitter 156 may include an electron emission structure 157 similar to the electron emission structure 132 described in relation to FIG. 3. However, other configurations for electron emission structure 157 are contemplated.

In the present embodiment, the emitter, such as flat emitter 156, includes a beam deflector indicated generally at 158. The beam deflector, also referred to herein, as an electrodynamic actuator, may be incorporated within focusing structure 152 described above, or may be in addition to, or substituted for, such focusing structure.

Beam deflector 158 may be segmented or partitioned such that it includes a plurality of deflective regions or steering portions. Each deflective region may be configured to produce an electric field that functions to deflect the electron beam and to steer the electron beam in a selected direction. The deflective regions are positioned adjacent the electron beam such that they may affect the electrons in the electron beam. In some embodiments, the deflective regions are arranged in pairs on opposing sides of the electron beam. For example, the deflective regions may be concentrically arranged around the electron beam. Thus, the deflective regions may form a ring around the electron beam.

For example, in the illustrated embodiment, the beam deflector 158 includes a plurality of deflective regions 160, 162, 164, and 166. Each deflective region includes a steering electrode, also referred to herein as a lens electrode, which may be configured to generate an electric field to steer the electron beam. In the illustrated embodiment, deflective regions 160, 162, 164, and 166 are arranged in opposing pairs. Each pair may be positioned along intersecting axes. For example, the steering electrodes may be positioned on an x-y Cartesian plane so as to affect the direction of travel of the emitted electron beam in both the x-direction and the y-direction. Thus, deflective regions 162 and 166 are disposed in the +x quadrant and −x quadrant, respectively, and may predominantly affect movement of the electron beam in the x-direction. Similarly, deflective regions 160 and 164 are disposed in the +y quadrant and −y quadrant, respectively and may predominantly affect movement of the electron beam in the y-direction. Typically, the steering electrodes are in a single plane. However, it is possible to arrange the steering electrodes in different planes.

In operation, application of electric potentials to the deflective regions enables the deflective regions to generate electric fields. Because the electrons in the electron beam are negatively charged, application of an electric field to the electron beam, results in an electrostatic force. The beam reacts to the applied potential, moving in response to the applied electric field. For example, an applied electric field may affect the electrons emitted from the electron emission structure, bending the trajectory of the electrons, and causing the electron beam to shift slightly in the x-direction and/or y-direction. Such a shift enables controlled steering of the electron beams.

The deflective regions in the beam deflector may be individually controlled, or may be controlled in pairs. For example, application of different potentials to opposing deflective regions 162 and 166, or to opposing deflective regions 160 and 164, result in the beam being steered toward or away from one of the deflective regions. Thus, the opposing deflective regions may be controlled as a unit. Alternatively, each deflective region may be individually controlled, raising or lowering its potential relative to a reference potential of the other deflective regions.

Although only four deflective regions are illustrated, it should be appreciated that any number of deflective regions may be used within the beam deflector, and that such deflective regions may be in any suitable geometrical arrangement. For example, there may be only two or three deflective regions, affecting the direction of travel in only the x-direction or the y-direction. Alternatively, there may be five, six or more deflective regions, affecting emitted electrons travel and enabling tighter control and steerage of the emitted electron beam.

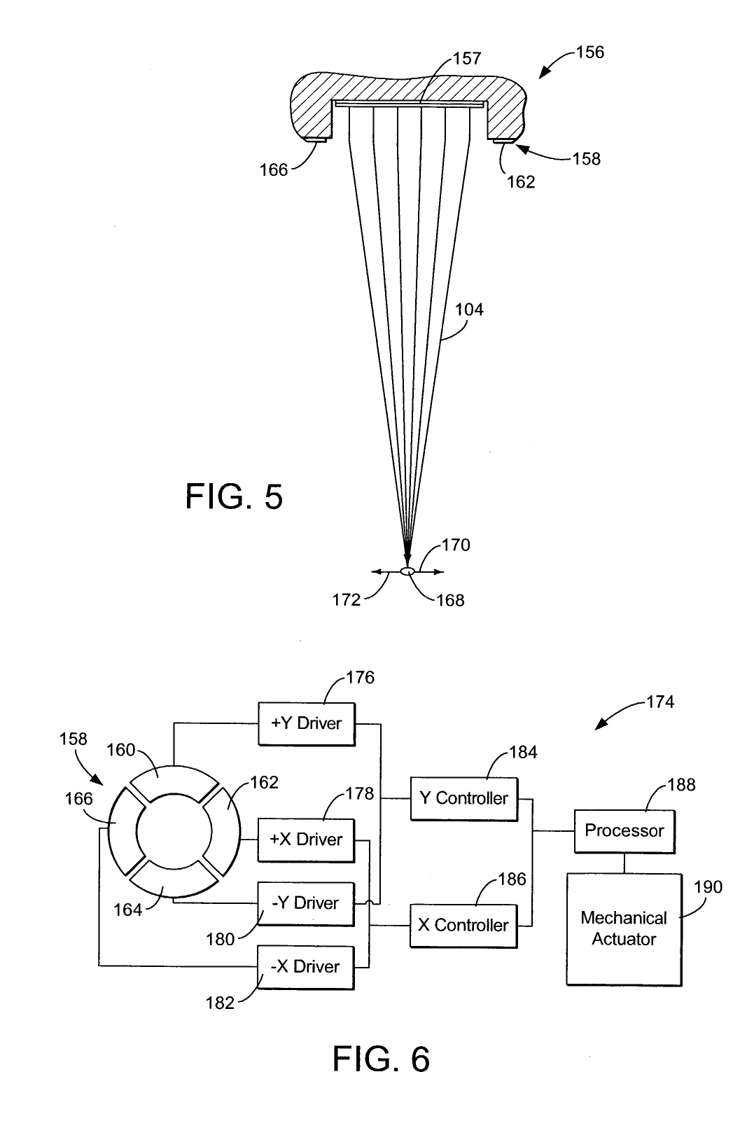

FIG. 5 further illustrates flat emitter 156 including electron emission structure 157 and beam deflector 158. Beam deflector 158 includes a plurality of deflective regions or steering electrodes, such as deflective regions 162 and 166. Application of different potentials to deflective regions 162 and 166 results in an electrical field that deflect the electrons in the electron beam 104 and enable selective steering of electron beam 104. By steering the electron beam, the resultant illuminated or image spot 168 may be selectively positioned on the storage medium. For example, electron beam 104 may be moved in the direction of arrow 170 or arrow 172. This ability to finely adjust the position of spot 168 enables more accurate alignment of the electron beam on a storage location.

Accurate alignment of the beam improves the reading and writing capabilities of the storage device. By finely positioning the electron beam, data may be precisely written onto a desired storage area. Improved reading occurs when the electron beam aligns with the previously recorded data spot. Such alignment of the beam also provides for increased accuracy in erasing data. For example, precise alignment of the beam with a prerecorded spot enables complete erasure and/or rewriting of the spot.

The beam deflector may limit aberrations, such as astigmatism, that result where the electron beams generated from an emitter do not converge on a single spot on the storage medium. For example, the electron beams may be misaligned or unfocused on a storage location. Such departures from ideal focusing may result in misregistered, misaligned, larger-than-ideal, blurred or imperfect spots. The beam deflector may enable correction of small misalignments between the electron beam and the storage location. The deflective regions may also be used jointly to reduce defocus. Thus, misalignments and defocus may be corrected by changing the potential across a pair of deflective regions, thus selectively deflecting the electron beam (and steering the beam) to a precise storage location, and thereby diminishing misregistration of the focused spot.

The beam deflector further provides for increased lateral acceleration of a scanned electron spot. Moreover, the beam deflector provides for nearly instantaneous start/stop motions, such as may be used in sharpening recorded spots during the writing process.

FIG. 6 depicts a schematic control circuit 174 for beam deflector 158 described above. Specifically, each deflective region 160, 162, 164, and 166 has a driver, 176, 178, 180, and 182, respectively. The drivers power the deflective regions such that they produce electric fields. Directional controllers, y-controller 184 and x-controller 186, control opposing deflective regions via corresponding driver pairs. For example, y-controller 184 drives drivers 176 and 180, and thus, controls opposing deflective regions 160 and 164. Correspondingly, x-controller 186 drives drivers 178 and 182, and thus, controls opposing deflective regions 162 and 166. It should be appreciated that the drivers may be incorporated within the controllers. A centralized processor 188 manages the controllers and drivers.

Processor 188 may further manage a mechanical actuator, or mover, 190. Such a mechanical actuator may be configured to scan the electronic beam relative to the storage medium. Thus, processor 188 may simultaneously drive the mechanical actuator and the beam deflector. In some embodiments, this hybrid system provides for compound motion of the electron beam. For example, the mechanical scanner may be supplemented with the beam deflector.

A hybrid system including both the beam deflector and the mechanical actuator provides for both coarse and fine positioning capabilities. By using both coarse and fine actuators, the electron beam may be quickly and accurately aligned with the storage medium, lowering error rates that result from misalignment. Typically, the mechanical actuator is configured for relatively large-scale motion, such as roughly aligning or coarsely positioning the electron beam with the appropriate data storage location. The mechanical actuator may also be used to scan or generally locate a data storage location on the storage medium. In contrast, the beam deflector operates as an electrodynamic fine actuator that is configured to provide minute corrections as to the placement or alignment of the electron beam. For illustrative purposes only, the beam deflector may move the beam in nanometer increments to align the beam with a precise storage location, while the mechanical actuator may move the electron beam (or storage device) in micrometer increments.

The hybrid system enables alignment of the electron beam resulting in sharper recorded marks and more complete erasure of previously recorded marks, thereby improving the performance of the storage device. Additionally, the beam deflector may be used to scan adjacent tracks or storage locations without necessitating the use of the mechanical actuator. The hybrid system provides for faster effective acceleration and deceleration of an electronic beam in comparison to a mechanical scanning system.

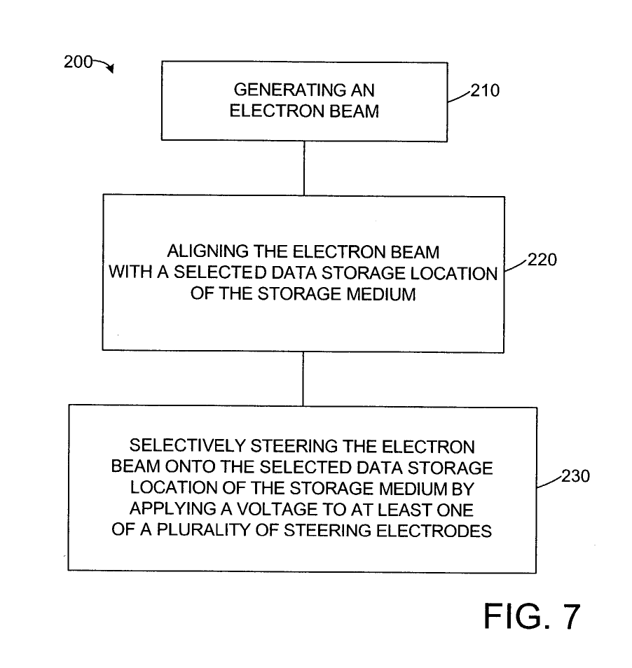

Referring now to FIG. 7, a method of aligning an electron beam to a data storage location on a storage medium is shown generally at 200. The method includes generating an electron beam (at 210), generally aligning the electron beam with a selected data storage location of the storage medium (at 220), and selectively steering the electron beam onto the selected data storage location of the storage medium by applying a voltage to at least one of a plurality of steering electrodes (at 230). The method also may include determining the state of the data storage location, such as, by writing to the data storage location or reading the state of the data storage location.

What is claimed is:

1. A data storage device comprising:
a storage medium having a data storage location;
at least one emitter adapted to emit an electron beam generally aligned with the data storage location; and
a beam deflector including plural steering electrodes configured to selectively adjust positional alignment of the electron beam relative the data storage location.

2. The data storage device of claim 1, wherein the steering electrodes are configured to selectively generate electric fields that effect the position of the electron beam.

3. The data storage device of claim 1, wherein the steering electrodes are adjacent the electron beam.

4. The data storage device of claim 1, wherein the steering electrodes are arranged in pairs on diametrically opposing sides of the electron beam.

5. The data storage device of claim 1, wherein the steering electrodes are peripherally arranged around the electron beam.

6. The data storage device of claim 1, wherein the steering electrodes form a ring around the electron beam.

7. The data storage device of claim 1, wherein there are four steering electrodes.

8. The data storage device of claim 1, wherein the steering electrodes are in a single plane.

9. The data storage device of claim 1, wherein the steering electrodes are positioned along intersecting axes.

10. The data storage device of claim 9, wherein the steering electrodes includes x-direction steering electrodes and y-direction steering electrodes.

11. The data storage device of claim 1, wherein the at least one emitter is a flat emitter.

12. The data storage device of claim 1, further comprising a processor configured to selectively control application of a potential to the steering electrodes.

13. A data storage device comprising:
a storage medium with a storage location;
an electron emitter configured to direct an electron beam toward the storage medium;
a first deflective region configured to generate a first electric field deflecting the electron beam and steering the electron beam in a first direction; and
a second deflective region configured to generate a second electric field deflecting the electron beam and steering the electron beam in a second direction;
wherein the first deflective region and second deflective region are selectively independently controlled to align the electron beam with the storage location.

14. The data storage device of claim 13, wherein each deflective region includes at least one steering electrode to which a voltage may be applied to produce an electric field.

15. The data storage device of claim 13, wherein the first and second deflective regions are adjacent the electron beam.

16. The data storage device of claim 13, wherein the first and second deflective regions are positioned on radially opposite sides of the electron beam.

17. The data storage device of claim 13, wherein the first and second deflective regions are peripherally arranged around the electron beam.

18. The data storage device of claim 13, wherein the first and second deflective regions form at least a portion of a ring around the electron beam.

19. The data storage device of claim 13, wherein the first and second deflective regions are in a single plane.

20. The data storage device of claim 13, wherein the first direction is perpendicular to the second direction.

21. The data storage device of claim 13, where the first direction is the x-direction and the second direction is the y-direction.

22. The data storage device of claim 13, further comprising a mechanical actuator configured to mechanically scan the electron beam over the storage medium.

23. The data storage device of claim 13, wherein the electron emitter is a flat emitter.

24. A data storage device comprising:
a storage medium including a plurality of data storage locations;
an emitter configured to produce an electron beam;
a mechanical actuator configured to coarsely position the electron beam relative to a selected data storage location of the storage medium; and
an electrodynamic actuator configured to finely position the electron beam relative to the selected data storage location of the storage medium.

25. The data storage device of claim 24, wherein the electrodynamic actuator includes plural deflective regions.

26. The data storage device of claim 25, wherein each deflective region includes at least one steering electrode configured to generate an electric field to deflect the electron beam in a selected direction.

27. The data storage device of claim 25, wherein the deflective regions are positioned adjacent the electron beam.

28. The data storage device of claim 25, wherein the deflective regions are positioned on radially opposite sides of the electron beam.

29. The data storage device of claim 25, wherein the deflective regions are peripherally arranged around the electron beam.

30. The data storage device of claim 24 further comprising a processor configured to drive both the mechanical actuator and the electrodynamic actuator.

31. The data storage device of claim 24, wherein the emitter is a flat emitter.

32. A method of aligning an electron beam to a data storage location on a storage medium, the method comprising:
generating an electron beam;
generally aligning the electron beam with a selected data storage location of the storage medium; and
selectively steering the electron beam onto the selected data storage location of the storage medium by applying a voltage to at least one of a plurality of steering electrodes.

33. The method of claim 32, wherein generally aligning the electron beam includes coarsely positioning the electron beam using a mechanical actuator.

34. The method of claim 32, further comprising configuring the steering electrodes substantially around the emitter.

35. The method of claim 32, further comprising determining the state of the data storage location.

36. The method of claim 35, wherein determining the state of the data storage location includes writing to the data storage location.

37. The method of claim 35, wherein determining the state of the data storage location includes reading the state of the data storage location.

38. A data storage device comprising:
means for storing having a data storage location;
means for generating an electron beam such that the electron beam is generally aligned with the data storage location; and
a means for finely steering the electron beam such that the electron beam is selectively positioned on the data storage location.

39. A data storage device comprising:
a storage medium having a data storage location;
at least one emitter adapted to emit an electron beam generally aligned with the data storage location; and
a beam deflector including plural steering portions configured to selectively adjust positional alignment of the electron beam relative the data storage location.
